(19) United States
(12) Patent Application Publication
(10) Pub. No.: US 2010/0060557 A1
(43) Pub. Date: Mar. 11, 2010

(54) DATA DE-SKEW BLOCK DEVICE AND METHOD OF DE-SKEWING TRANSMITTED DATA

(75) Inventor: Chuan-Chien Hsu, Tainan (TW)

Correspondence Address: BAKER & MCKENZIE LLP;PATENT DEPARTMENT, 2001 ROSS AVENUE, SUITE 2300, DALLAS, TX, 75201, US

(73) Assignee: HIMAX TECHNOLOGIES LIMITED, Tainan (TW)

(21) Appl. No.: 12/208,061

(22) Filed: Sep. 10, 2008

(51) Int. Cl. G09G 3/36; H04L 7/00

(52) U.S. Cl. 345/87; 375/354

(57) ABSTRACT

A source driver device includes a de-skew block device for receiving image data and clock signals, the de-skew block device has a receiver for receiving a clock signal and image data, a delay lock loop for generating a plurality of sub-clock signals, each having different delay times increasing in order, based on the clock signal, an edge detection unit for finding an edge of the data by the sub-clocks, and selecting one from the sub-clocks based on the edge as a de-skewed clock, and a data de-skew unit for sampling the image data by the de-skewed clock signal to output de-skewed image data and the de-skewed clock signal, and a plurality of channels for receiving the de-skewed image data and the de-skewed clock signal to drive an LCD panel.

### BACKGROUND

1. Technical Field

The embodiments described herein relate to a driver device and, more particularly, to a data de-skew block device and a method of de-skewing transmitted data.

2. Related Art

A conventional liquid crystal display (LCD) module commonly includes a gate driver, a source driver, an LCD panel, a timing controller, and a power circuit. The source driver receives data from an interface device, such as a Reduced Swing Differential Signaling (RSDS) interface, to output driving voltage signals to the LCD panel.

The timing controller (TCON) can include different types of controller device and/or controller settings. These TCON differences skew the data, which is sent to the source driver or the gate driver, and varies greatly. Accordingly, the data is not correctly output and transmitted to the LCD panel. Thus, a source driver having a data de-skew block device is required to correctly output and transmit the data to the LCD panel.

### SUMMARY

A source driver having a data de-skew block device and a method of de-skewing transmitted data are described herein.

In one aspect, a source driver device includes a de-skew block device for receiving image data and clock signals, the de-skew block device has a receiver for receiving a clock signal and image data, a delay lock loop for generating a plurality of sub-clock signals, each having different delay times increasing in order, based on the clock signal, an edge detection unit for finding an edge of the data by the sub-clocks, and selecting one from the sub-clocks based on the edge as a de-skewed clock, and a data de-skew unit for sampling the image data by the de-skewed clock signal to output de-skewed image data and the de-skewed clock signal, and a plurality of channels for receiving the de-skewed image data and the de-skewed clock signal to drive an LCD panel.

In another aspect, a method of de-skewing transmitted data includes receiving a clock signal and image data, generating a plurality of sub-clock signals with different delay times increasing in order, based upon the clock signal, finding an edge of a signal of the image data by the sub-clock signals, and selecting one from the sub-clock signals based on the edge as a de-skewed clock signal, and

sampling the image data by the de-skewed clock signal.

These and other features, aspects, and embodiments are described below in the section “Detailed Description.”

### BRIEF DESCRIPTION OF THE DRAWINGS

Features, aspects, and embodiments are described in conjunction with the attached drawings, in which:

FIG. 1 is a schematic circuit diagram of an exemplary source driver device according to one embodiment;

FIG. 2 is a schematic circuit diagram of an exemplary de-skew block device according to one embodiment; and

FIG. 3 is a timing diagram demonstrating exemplary clock signals and sub-clock signals according to one embodiment.

### DETAILED DESCRIPTION

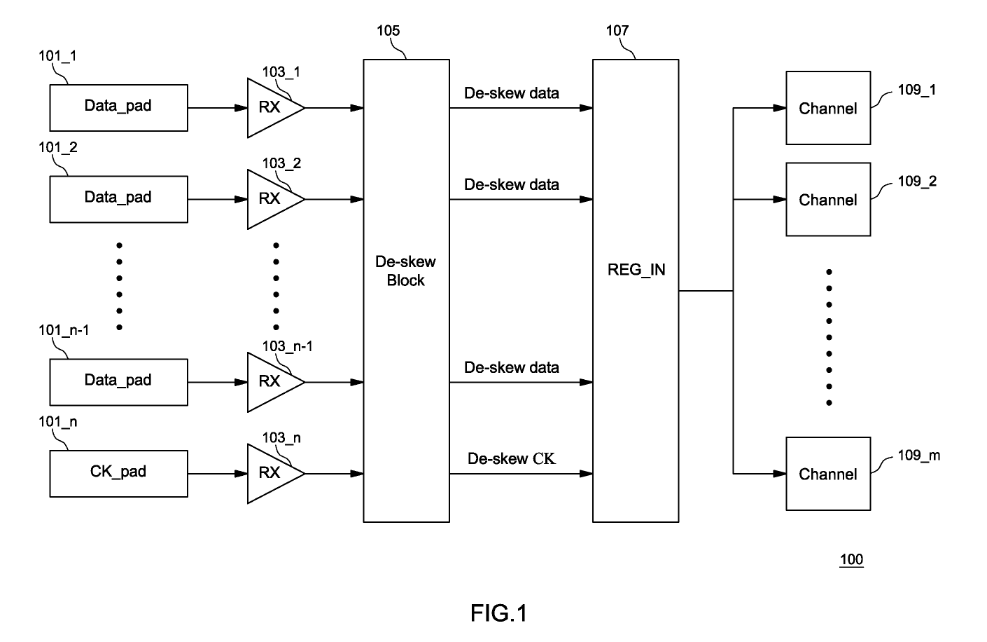

FIG. 1 is a schematic circuit diagram of an exemplary source driver device according to one embodiment. In FIG. 1, a

source driver 100 can be configured to include a plurality of input data pads (Data_pad) 101_1 to 101_{—}n−1 and a clock pad (CK_pad) 101_{—}n, a plurality of receivers (RX) 103_1 to 103_{—}n, a de-skew block device 105, a register (REG_IN) 107, and a plurality of channels 109_1 to 109_{—}m for receiving de-skewed data and de-skewed clock signals ‘CK’ to drive an LCD panel.

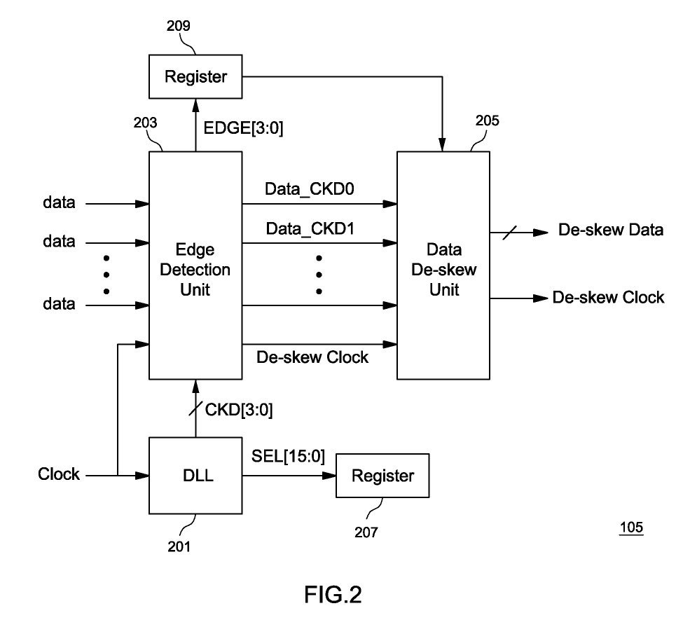

FIG. 2 is a schematic circuit diagram of an exemplary de-skew block device according to one embodiment. In FIG. 2, the de-skew block 105 can be configured to include a delay lock loop (DLL) 201, an edge detection unit 203, a data de-skew unit 205, and first and second registers 207 and 209. Each of the plurality of receivers 103_1 to 103_{—}n (of FIG. 1) can receive image data or a clock signal. The delay lock loop 201 can generate a plurality of sub-clock signals, ‘CKD[0]’ to ‘CKD[3]’, each having different delay times increasing in order, based on clock signals. For example, each of the delay times can preferably be not greater than one-half of a cycle of the clock signal.

The edge detection unit 203 can find an edge of the image data by the sub-clock signals and can select one from the sub-clock signals ‘CKD[3:0]’ based upon the edge as a de-skewed clock signal. The data de-skew unit 205 can sample the image data by the de-skewed clock signal to output de-skewed data and the de-skewed clock signal.

The edge detection unit 203 can sequentially sample the image data by the sub-clock signals ‘CKD[3:0]’, and can determine that the edge can be found if the image data sampled by one sub-clock signal is different from a previous sampling of the image data by a former sub-clock signal.

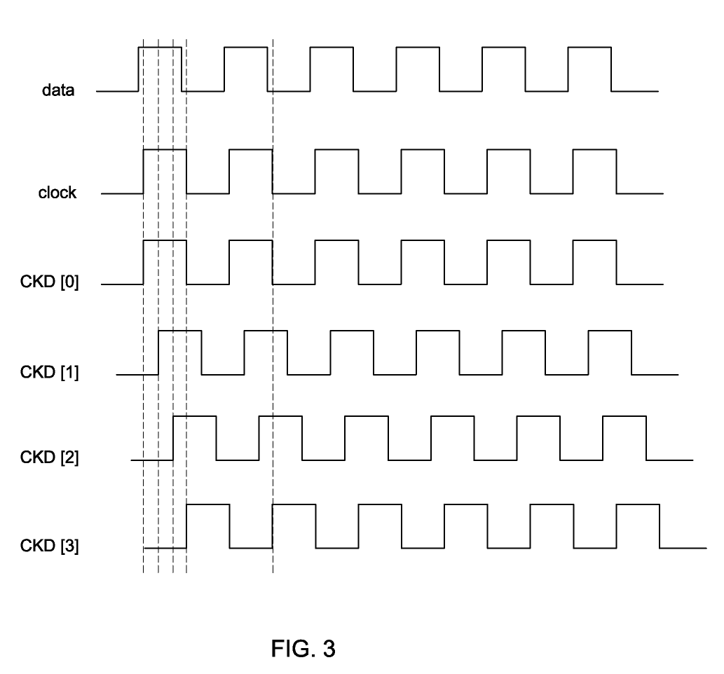

FIG. 3 is a timing diagram demonstrating exemplary clock signals and sub-clock signals according to one embodiment. In FIG. 3, if the image data sampled by the sub-clock signal ‘CKD[2]’ is a “1”, and if the image data sampled by the sub-clock signal ‘CKD[3]’ is a “0”, then the sub-clock signal ‘CKD[1]’ can be selected as a de-skewed clock signal because the sub-clock signal ‘(2)’ can be aligned to an edge of the image data signal. The edge detection unit 203 can select a former sub-clock signal as the de-skewed clock signal. There are an n-number of sub-clock signals ‘CRD[n:0]’, wherein “n” is a positive integer. The edge detection unit 203 can sample the image data by the sub-clock signals, i.e., from the sub-clock signal ‘CKD[0]’ to the sub-clock signal ‘CKD[n]’. In addition, the edge detection unit 203 can determine that the edge is found if the image data sampled by the sub-clock signal ‘CKD[i+1]’ is different from the previous image data sampled by the sub-clock signals ‘CKD[i]’, wherein “i” is an integer between 0 to n.

The edge detection unit 203 can select the sub-clock signal ‘CKD[i]’ as the de-skewed clock signal. The edge detection unit 203 can also select the sub-clock signal ‘CKD[i−1]’ as the de-skewed clock signal. The plurality of edges of the image data can be edges selected from a group include a leading edge, a trailing edge, a rising edge, and a falling edge.

According to one embodiment, the source driver can be configured to include the edge detection unit that can detect sub-clock signals to correct skew of image data. Accordingly, the source driver is capable of correctly mapping and transmitting the image data. The source driver can receive and correctly transmit RSDS data having different skews within a frequency range of about 30 MHz to about 180 MHz.

An exemplary method of de-skewing transmitted image data signals can include a generating step, a finding step, a selecting step, and a sampling step. In the generating step, a plurality of sub-clock signals, with different delay times in an increasing order, can be generated based upon a clock signal. In the finding step, an edge of the image data signal can be founded using the sub-clock signals. In the selecting step, one from the sub-clock signals can be selected based upon the edge, as a de-skewed clock signal. In the sampling step, the image data can be sampled by the de-skewed clock signal.

The step of finding the edge can include steps of sampling the image data by the sub-clock signals, and can determine that the edge is found if the image data sampled by a current sub-clock signal is different from sampled image data of a previous sub-clock signal. In the selecting step, the previous sub-clock signal may be selected as the de-skewed clock signal.

The step of finding the edge can include steps of sampling the image data by the sub-clock signals, i.e., from the sub-clock signal ‘CKD[0]’ to the sub-clock signal ‘CKD[n]’, and can determine that the edge is found if the image data sampled by the sub-clock signal ‘CKD[i+1]’ is different from the image data sampled by the sub-clock signals ‘CKD[i]’, wherein “i” is an integer between 0 to “n”, and “n” is an integer greater than zero. In the selecting step, the sub-clock signal ‘CKD[i]’ can be selected as the de-skewed clock signal, or the sub-clock signal ‘CKD[i−1]’ can be selected as the de-skewed clock signal.

In FIG. 3, if the image data sampled by the sub-clock signal ‘CKD[2]’ is a “1”, and if the image data sampled by the sub-clock signal ‘CKD[3]’ is a “0”, then the sub-clock signal ‘CKD[1]’ can be selected as a de-skewed clock signal because the sub-clock signal ‘CKD[2]’ can be aligned to an edge of the image data signals.

For example, each of the delay times cannot be greater than a one-half cycle T of the clock signal. In FIG. 3, the delay times are shown as 0, ¼T, 2/4T, and ¾T. Accordingly, the exemplary method can further include steps of storing the delay times, or the one-half cycle T of the clock signal, to a first register, mapping and transmitting the output data to a plurality of channels by a second register, and storing edge-detecting information to a third register.

The channels of the source drivers receive de-skewed clock signals and de-skewed image data to drive an LCD panel. The plurality of edges of the image data signals can be edges selected from a group including a leading edge, a trailing edge, a rising edge, and a falling edge. Each of the plurality of sub-clock signals can have at least one edge for aligning and sampling the image data signals. The edge of the clock signal may be an edge selected from a group including a leading edge, a trailing edge, a rising edge, and a falling edge.

By using the sub-clock signals, skew of the image data can be corrected. Accordingly, the source driver is capable of correctly mapping and transmitting the image data. The source driver can receive and correctly transmit RSDS data having different skews within a frequency range of about 30 MHz to about 180 MHz.

An exemplary method of de-skewing image data of a clock signal is now explained. Here, the clock signal may have an edge selected from a group including a leading edge, a trailing edge, a rising edge, and a falling edge. The image data of the clock signal is de-skewed by, for example, sampling a plurality of sub-clock signals individually.

In FIG. 3, the sub-clock signal ‘CKD[0]’, sub-clock signal ‘CKD[1]’, sub-clock signal ‘CKD[2]’, and sub-clock signal ‘CKD[3]’ can be generated by, for example, delaying the clock signal. Each of the sub-clock signals has at least one edge for being aligned and/or sampled. The sub-clock signal ‘CKD[0]’, with a first delay time, has a first edge. The sub-clock signal ‘CKD[1]’, with a second delay time, has a second edge. The sub-clock signal ‘CKD[2]’, with a third delay time, has a third edge. Preferably, the first delay time is zero, and the third delay time is longer than the second delay time.

The first edge, the second edge, and/or the third edge can be detected. Based upon the detected edges, a data sampling step can be subsequently performed. For example, the first edge of the sub-clock signal ‘CKD(0)’ can be detected in order to determine if the sub-clock signal ‘CKD(0)’ is aligned to the image data of the clock signal. If the sub-clock signal ‘CKD(0)’ is aligned to the image data of the clock, then the first data of the sub-clock signal ‘CKD(0)’ can be sampled and output.

In another case, for example, the third edge of the sub-clock signal ‘CKD(2)’ can also be detected in order to determine if the sub-clock signal ‘CKD(2)’ is aligned to the image data of the clock signal. If the sub-clock signal ‘CKD(2)’ is aligned to the image data of the clock signal, then the third data of the sub-clock signal ‘CKD(2)’ can be sampled and output.

In both instances, the output data can be mapped and transmitted to a plurality of channels by a second register, wherein the plurality of channels can be arranged within an LCD panel.

The sub-clock signal ‘CKD(3)’, with a fourth delay time preferably longer than the third delay time, has a fourth data and a fourth edge. The fourth edge, the first edge, the second edge, and the third edge may be edges selected from a group including a leading edge, a trailing edge, a rising edge, and a falling edge.

Since the TCON differences skew of the image data varies within a range of about one-half cycle of a clock signal, a one-half period of a clock signal de-skewing device can be calculated. The calculated one-half period can be stored to a first register. Accordingly, the first delay time can be substantially zero, the second delay time can be about a one-eighth period of the clock de-skewing device, the third delay time can be about a two-eighths period of the clock de-skewing device, and the fourth delay time can be about a three-eighths period of the clock de-skewing device.

The first delay time can be obtained by, for example, multiplying the one-half period by zero. The second delay time can be obtained by, for example, multiplying the one-half period by one-fourth (¼). The third delay time can be obtained by, for example, multiplying the one-half period by two-fourth ( 2/4). The fourth delay time can be obtained by, for example, multiplying the one-half period by three-fourths (¾). Here, the detecting step of the first edge, second edge, or third edge can include edge-detecting information, and can be stored in a third register.

By sampling the image data by different sub-clock signals, skew of a clock signal and skew of image data can be corrected. Accordingly, the source driver is capable of correctly receiving the image data. The source driver can receive and correctly transmit RSDS data having different skews within a frequency range of about 30 MHz to about 180 MHz.

While certain embodiments have been described above, it will be understood that the embodiments described are by way of example only. Accordingly, the device and method described herein should not be limited based on the described embodiments. Rather, the devices and methods described herein should only be limited in light of the claims that follow when taken in conjunction with the above description and accompanying drawings.

What is claimed is:

1. A source driver device, comprising:
a de-skew block device for receiving image data and clock signals, the de-skew block device includes:
a receiver for receiving a clock signal and image data;
a delay lock loop for generating a plurality of sub-clock signals,
each having different delay times increasing in order, based on the clock signal;
an edge detection unit for finding an edge of the data by the sub-clocks, and selecting one from the sub-clocks based on the edge as a de-skewed clock; and
a data de-skew unit for sampling the image data by the de-skewed clock signal to output de-skewed image data and the de-skewed clock signal, and
a plurality of channels for receiving the de-skewed image data and the de-skewed clock signal to drive an LCD panel.

2. The source driver device of claim 1, wherein the edge detection unit samples the image data by the sub-clock signals, and determines that an edge of a signal of the image data is found if the image data sampled by a current sub-clock signal is different from image data sampled by a previous sub-clock signal.

3. The source driver device of claim 2, wherein the edge detection unit selects the previous sub-clock signal as the de-skewed clock signal.

4. The source driver device of claim 1, wherein the edge detection unit samples the image data by the sub-clock signals, from a sub-clock signal (0) to a sub-clock signal (n), and determines that the edge of a signal of the image data is found if image data sampled by a sub-clock signal (i+1) is different from the image data sampled by a sub-clock signal (i), wherein i is an integer between 0 to n, and n is an integer greater than zero.

5. The source driver device of claim 4, wherein the edge detection unit selects the sub-clock signal (i) as the de-skewed clock signal.

6. The source driver device of claim 4, wherein the edge detection unit selects a sub-clock signal (i−1) as the de-skewed clock signal.

7. The source driver drover of claim 1, wherein each of the delay times is not greater than a one-half cycle of the clock signal.

8. The source driver device of claim 1, wherein the de-skew block device includes a first register for storing the delay times.

9. The source driver device of claim 1, wherein the de-skew block device includes a second register for mapping and transmitting the output data.

10. The source driver device of claim 1, wherein an edge of a signal of the image data is selected from a group including a leading edge, a trailing edge, a rising edge, and a falling edge.

11. A method of de-skewing transmitted data, comprising:
receiving a clock signal and image data;
generating a plurality of sub-clock signals with different delay times increasing in order, based upon the clock signal;
finding an edge of a signal of the image data by the sub-clock signals; and
selecting one from the sub-clock signals based on the edge as a de-skewed clock signal; and
sampling the image data by the de-skewed clock signal.

12. The method of claim 11, wherein the step of finding the edge comprises:
sampling the image data by the sub-clock signals; and
determining that the edge is found if the image data sampled by a current sub-clock signal is different from image data sampled by a previous sub-clock signal.

13. The method of claim 12, wherein the selecting step selects the previous sub-clock signal as the de-skewed clock signal.

14. The method of claim 12, wherein the step of finding the edge comprises:
sampling the image data by the sub-clock signals, from a sub-clock signal (0) to a sub-clock signal (n); and
determining that the edge is found if the image data sampled by a sub-clock signal (i+1) is different from the image data sampled by a sub-clock signal (i),
wherein i is an integer between 0 to n, and n is an integer greater than zero.

15. The method of claim 14, wherein the selecting step selects the sub-clock signal (i) as the de-skewed clock signal.

16. The method of claim 14, wherein the selecting step selects the sub-clock signal (i−1) as the de-skewed clock signal.

17. The method of claim 11, wherein each of the delay times are not greater than a one-half cycle of the clock signal.

18. The method of claim 11, wherein the plurality of edges of the image data are edges selected from a group including a leading edge, a trailing edge, a rising edge, and a falling edge.
